(19) United States
(12) Patent Application Publication
(10) Pub. No.: US 2016/0046079 A1
(43) Pub. Date: Feb. 18, 2016

(54) Ultra-Violet Curable Gel Ink And Process

(71) Applicant: Xerox Corporation, Norwalk, CT (US)

(72) Inventors: Jennifer L. Belelie, Oakville (CA); Barkev Keoshkerian, Thornhill (CA); Marcel P. Breton, Mississauga (CA); Naveen Chopra, Oakville (CA); Michelle N. Chrétien, Mississauga (CA)

(73) Assignee: Xerox Corporation

(21) Appl. No.: 14/457,681

(22) Filed: Aug. 12, 2014

(51) Int. Cl. B29C 67/00

(52) U.S. Cl. CPC B29C 67/0092; B29C 67/007; B33Y 10/00

(57) ABSTRACT

A process including depositing a non-curable wax to form a mold; depositing one or more layers of an ultra-violet curable phase change gellant ink onto the mold; curing the ink layers; and removing the mold. A process including an ink set comprising a plurality of differently colored curable phase change inks, wherein each ink of the ink set comprises an ink vehicle, a gelling agent, a pigment, and a dispersant, wherein the dispersant is identical in each colored ink and the dispersant is present in a substantially same amount in each colored ink; combining at least two inks from the set prior to depositing; melting the at least two inks; mixing the at least two inks to form a custom color ink; depositing one or more layers of the custom color ink onto the mold; curing the one or more layers; and removing the mold.

### BACKGROUND

Disclosed herein is an ultra-violet curable phase change gellant ink and process for three-dimensional ink jet manufacturing using said ink. More particularly, disclosed herein is a process comprising depositing a non-curable wax to form a support or a mold; depositing one or more layers of an ultra-violet curable phase change gellant ink onto the non-curable wax support or mold; curing the ultra-violet curable phase change gellant ink layer or layers; and removing the non-curable wax support or mold.

Known three dimensional printing processes include depositing a layer of an ultra-violet curable material to a support, immediately curing the layer, depositing a second layer, immediately curing the second layer, and so on, in order to build up a desired number of layers. When the desired number of layers are each deposited and individually cured, the support material is removed, such as by washing, melting, or blasting, depending on the nature of the support. Typically, the three-dimensional object must be made and then painted afterward due to the difficulty in imparting color to ultra-violet curable materials acceptable for this type of process. Currently, there are a limited number of colors of ultra-violet curable materials. Ultra-violet curable materials can be difficult or impossible to color and in particular, are not readily pigmented and can actually be resistant to pigment colorants.

Currently available inks and processes are suitable for their intended purposes. However a need remains for improved inks suitable for three-dimensional ink jet manufacturing. Further, a need remains for an improved ink and three-dimensional printing process enabling ready creation of inherently colored three-dimensional fabrications. Further, a need remains for an improved ink and three-dimensional printing process providing material that is easy to work with and readily pigmented.

The appropriate components and process aspects of the each of the foregoing U.S. patents and Patent Publications may be selected for the present disclosure in embodiments thereof. Further, throughout this application, various publications, patents, and published patent applications are referred to by an identifying citation. The disclosures of the publications, patents, and published patent applications referenced in this application are hereby incorporated by reference into the present disclosure to more fully describe the state of the art to which this invention pertains.

### SUMMARY

Described is a process comprising depositing a non-curable wax to form a support or a mold; depositing one or more layers of an ultra-violet curable phase change gellant ink onto the non-curable wax support or mold; curing the ultra-violet curable phase change gellant ink layer or layers; and removing the non-curable wax support or mold.

Also described is a process comprising depositing a non-curable wax to form a support or a mold; providing an ultra-violet curable phase change gellant ink comprising an ink set comprising a plurality of differently colored curable phase change inks, wherein each colored ink of the ink set is comprised of an ink vehicle, a gelling agent, a pigment, and a dispersant, wherein the dispersant is identical in each colored ink of the ink set and the dispersant is present in a substantially same amount in each colored ink of the ink set; combining at least two inks from the ink set prior to depositing; melting the at least two inks; mixing the at least two inks to form a custom color ultra-violet curable phase change gellant ink; depositing one or more layers of the custom color ultra-violet curable phase change gellant ink onto the non-curable wax support or mold; optionally, cooling the deposited one or more layers of the custom color ultra-violet curable phase change gellant ink; curing the one or more layers of the ultra-violet curable phase change gellant ink layer or layers; and removing the non-curable wax support or mold.

Also described is a process comprising depositing a non-curable wax to form a support or a mold; depositing one or more layers of an ultra-violet curable phase change gellant ink onto the non-curable wax support or mold; wherein the surface of the deposited support or mold is untreated and the one or more layers of ultra-violet curable phase change gellant ink are deposited onto the untreated non-curable wax support or mold; curing the ultra-violet curable phase change gellant ink layer or layers; and removing the non-curable wax support or mold.

### BRIEF DESCRIPTION OF THE DRAWINGS

FIG. 1 is a viscosity profile for ultra-violet curable phase change gellant inks suitable for a three-dimensional ink jet printing process in accordance with the present disclosure.

### DETAILED DESCRIPTION

A process is provided comprising depositing a non-curable wax to form a support or a mold; depositing one or more layers of an ultra-violet curable phase change gellant ink onto the non-curable wax support or mold; curing the ultra-violet curable phase change gellant ink layer or layers; and removing the non-curable wax support or mold.

In embodiments, the present ultra-violet curable gel ink process contemplates jetting down a framework as a mold, in embodiments, wherein the framework is a non-curable wax support or mold. The process then contemplates jetting the ultra-violet curable ink on top of the non-curable wax support or mold, curing the ink, and then removing the mold. While previous processes required building up a desired three-dimensional object with the material ink, the present embodiments provide using a scaffold, such as the non-curable wax support or mold, and jetting the ultra-violet curable phase change gellant ink onto the scaffold to fabricate the three-dimensional object. The final product of the process herein is thus easier to work with and easier to pigment than prior processes which often required fabrication and then painting afterward. The present processes provide an ultra-violet curable phase change gellant ink that is easy to color and readily takes pigment in particular. Thus, a three-dimensional object prepared with the present process is inherently colored and does not require painting afterward.

Any suitable or desired scaffold, support, mold, or similar receiving substrate can be used for the present process. The receiving substrate, referred to herein variously as receiving substrate, scaffold, support, mold, can comprise any suitable or desired material.

In embodiments, the receiving substrate comprises a non-curable wax scaffold, support, or mold. The non-curable wax can be any suitable or desired material. The non-curable wax can be any suitable non-curable wax component that is a solid at room temperature. By non-curable component, it is meant that the component does not react via free radical polymerization or is not radiation curable or not significantly radiation curable. In some embodiments, the support and build materials have similar thermal properties (melt and solidification temperatures) and viscosities at the jetting temperature. In other embodiments, the materials will have dissimilar thermal properties and viscosities at the jetting temperature. In preferred embodiments, the build and support materials have similar thermal properties and viscosities at the jetting temperature to allow the use of a single print head assembly. Additives, such as viscosity modifiers, can be added to non-curable wax of the support material to customize the properties, such as jetting, removal, etc., as required. In embodiments, the non-curable wax can be a member of the group consisting of hydrocarbon waxes, alcohol waxes, acid waxes, acid or alcohol waxes esterified with mono or polyvalent alcohols, or blends of acid waxes having different degrees of esterification, and combinations thereof.

In one embodiment, the non-curable wax is an ester wax. In another embodiment, the non-curable wax is a derivative of montan wax. In another embodiment, the non-curable wax is an alcohol. In another embodiment, the non-curable wax is an acid. In another embodiment, the non-curable wax can be an ester wax such as Licowax® KFO (commercially available from Clariant) or Kester® Wax K-72 (commercially available from Koster Keunen). In another embodiment, the non-curable wax is a custom derivative of ethoxylated octylphenols, as described in U.S. Patent Publication Number 20110196057, which is hereby incorporated by reference herein in its entirety. In another embodiment, the non-curable wax is a hydrocarbon wax, such as Polywax® 500 (commercially available from Baker Hughes).

In embodiments, the non-curable wax is selected from the group consisting of ester waxes, alcohol waxes, acid waxes, hydrocarbon waxes, and mixtures and combinations thereof. These materials are available as Unilin® 350 or Polywax® 500 (both commercially available from Baker Hughes), Licowax® S, Licowax® LP, Licowax® SW, Licowax® KSS and Licolub® WM 31 (all commercially available from Clariant) and Kester® Wax K-72 (commercially available from Koster Keunen).

In embodiments, viscosity modifiers can be included. The viscosity modifiers can be a member of the group consisting of hydrocarbon waxes. Specific examples include Piccotac™ 1020, Piccotac™ 1020E and Abalyn™ D-E Methyl Ester of Rosin, all commercially available from Eastman and Basewax® 7796, commercially available from Paramelt. In other embodiments, the viscosity modifier is a didodecylurea or dioctadecylurea, prepared as described in Example I of U.S. Pat. No. 7,665,835, which is hereby incorporated by reference herein in its entirety.

The receiving substrate can be fabricated by any suitable or desired process. For example, a scaffold, support, or mold can be formed by melting the non-curable wax, depositing the molten non-curable wax into a mold, cooling to a temperature sufficient to solidify the wax, and then removing the formed item from the mold.

The non-curable wax can be deposited to form a support or mold. In embodiments, depositing the non-curable wax comprises ink jetting the non-curable wax to form the support or mold.

Previously, it was required to treat the surface of the receiving substrate is treated to enhance the receptivity of the substrate surface for the ink. Such treatment included disposing a coating on the surface of the receiving substrate or treating so as to provide a roughened or patterned surface to the substrate. Advantageously, such treatment is not required for the instant embodiments. These previous required treating steps are not necessary. In embodiments, the present employs UV gel ink which adheres to many different substrates and has a slight affinity for wax. In embodiments, the formulations herein can tolerate 30% of certain waxes. Thus, in embodiments, the process herein comprises depositing a non-curable wax to form a support or a mold, wherein the surface of the support or mold is untreated and the one or more layers of an ultra-violet curable phase change gellant ink are deposited onto the untreated non-curable wax support or mold. In other embodiments, the surface of the deposited support or mold is untreated and the one or more layers of the custom color ultra-violet curable phase change gellant ink are deposited onto the untreated non-curable wax support or mold.

Any suitable or desired ink can be selected for the process. In embodiments, the inks are curable phase changes inks, desirably radiation curable phase change inks, for example, curable by exposure to ultra-violet radiation. The inks are in a solid or gel state at room temperature or ambient temperature (about 25° C.). To jet the inks, the inks are heated above their melt temperature to change to a liquid or jettable phase. In embodiments, an ultra-violet curable gellant ink is selected wherein the ultra-violet curable gellant ink is an ink that allows easy pigment incorporation and thus enables a wide variety of colors. In further embodiments, an ultra-violet curable gellant ink is selected which ink has the ability to print individual layers of from about 10 micrometers to about 5 millimeters in thickness before curing.

In embodiments, an ultra-violet curable gellant ink suitable for the present selective deposition modeling process comprises an amide gellant, at least one acrylate monomer, at least one photoinitiator, and at least one pigment.

The ink herein can include any suitable or desired gelling agent or gellant. In embodiments, an amide gellant can be selected. The amide gellant can be any suitable or desired amide gellant. The amide gellant includes those disclosed in U.S. Pat. No. 8,142,557, which is hereby incorporated by reference herein in its entirety. The amide gellant may be of the formula

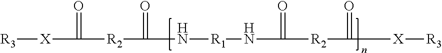

wherein R₁ is: (i) an alkylene group (wherein an alkylene group is defined as a divalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphorus, boron, and the like either may or may not be present in the alkylene group), with from, for example, 1 to about 20 carbon atoms in the alkylene chain, such as from 1 to about 12 or from 1 to about 4 carbon atoms.

(ii) an arylene group (wherein an arylene group is defined as a divalent aromatic group or aryl group, including substituted and unsubstituted arylene groups, and wherein heteroatoms, such as oxygen, nitrogen, sulfur, silicon, phosphorus, boron, and the like either may or may not be present in the arylene group), with from, for example, about 5 to about 20 carbon atoms in the arylene chain, such as from about 6 to about 14 or from about 6 to about 10 carbon atoms,

(iii) an arylalkylene group (wherein an arylalkylene group is defined as a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkylene group), with from, for example, about 6 to about 32 carbon atoms in the arylalkylene chain, such as from about 7 to about 22 or from about 7 to about 20 carbon atoms, or

(iv) an alkylarylene group (wherein an alkylarylene group is defined as a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group), with from, for example, about 6 to about 32 carbon atoms in the alkylarylene chain, such as from about 7 to about 22 or from about 7 to about 20 carbon atoms, wherein the substituents on the substituted alkylene, arylene, arylalkylene, and alkylarylene groups can be, for example, halogen atoms, cyano groups, pyridine groups, pyridinium groups, ether groups, aldehyde groups, ketone groups, ester groups, amide groups, carbonyl groups, thiocarbonyl groups, sulfide groups, nitro groups, nitroso groups, acyl groups, azo groups, urethane groups, urea groups, mixtures thereof, and the like, wherein two or more substituents can be joined together to form a ring;

R₂ is (i) alkylene groups (wherein an alkylene group is defined as a divalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphorus, boron, and the like either may or may not be present in the alkylene group), with from, for example, 1 to about 54 carbon atoms in the alkylene chain, such as from 1 to about 44 or from 1 to about 36 carbon atoms,

(ii) arylene groups (wherein an arylene group is defined as a divalent aromatic group or aryl group, including substituted and unsubstituted arylene groups, and wherein heteroatoms, such as oxygen, nitrogen, sulfur, silicon, phosphorus, boron, and the like either may or may not be present in the arylene group), with from, for example, 5 to about 14 carbon atoms in the arylene chain, such as from 6 to about 14 or from 7 to about 10 carbon atoms,

(iii) arylalkylene groups (wherein an arylalkylene group is defined as a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkylene group), with from, for example, about 6 to about 32 carbon atoms in the arylalkylene chain, such as from about 7 to about 22 or from 8 to about 20 carbon atoms, or

(iv) alkylarylene groups (wherein an alkylarylene group is defined as a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group), with from, for example, about 6 to about 32 carbon atoms in the alkylarylene chain, such as from about 7 to about 22 or from about 7 to about 20 carbon atoms, wherein the substituents on the substituted alkylene, arylene, arylalkylene, and alkylarylene groups can be, for example, halogen atoms, cyano groups, ether groups, aldehyde groups, ketone groups, ester groups, amide groups, carbonyl groups, thiocarbonyl groups, phosphine groups, phosphonium groups, phosphate groups, nitrile groups, mercapto groups, nitro groups, nitroso groups, acyl groups, acid anhydride groups, azide groups, azo groups, cyanato groups, urethane groups, urea groups, mixtures thereof, and the like, wherein two or more substituents can be joined together to form a ring;

R₃ is (i) alkyl groups, including linear and branched, saturated and unsaturated, cyclic and acyclic, and substituted and unsubstituted alkyl groups, and wherein heteroatoms either may or may not be present in the alkyl group, (ii) aryl groups, including substituted and unsubstituted aryl groups, wherein heteroatoms either may or may not be present in the aryl group, (iii) arylalkyl groups, including substituted and unsubstituted arylalkyl groups, wherein the alkyl portion of the arylalkyl group can be linear or branched, saturated or unsaturated, and cyclic or acyclic, and wherein heteroatoms either may or may not be present in either the aryl or the alkyl portion of the arylalkyl group, or (iv) alkylaryl groups, including substituted and unsubstituted alkylaryl groups, wherein the alkyl portion of the alkylaryl group can be linear or branched, saturated or unsaturated, and cyclic or acyclic, and wherein heteroatoms either may or may not be present in either the aryl or the alkyl portion of the alkylaryl group, X is an oxygen atom or a group of the formula —NR₄—, wherein R₄ is: (i) a hydrogen atom, (ii) an alkyl group, comprising linear or branched, saturated or unsaturated, cyclic or acyclic, and substituted or unsubstituted alkyl groups, and wherein heteroatoms either may or may not be present in the alkyl group, (iii) an aryl group, comprising substituted or unsubstituted aryl groups, and wherein heteroatoms either may or may not be present in the aryl group, (iv) an arylalkyl group, comprising substituted or unsubstituted arylalkyl groups, wherein the alkyl portion of the arylalkyl group can be linear or branched, saturated or unsaturated, or cyclic or acyclic, or wherein heteroatoms either may or may not be present in either the aryl or the alkyl portion of the arylalkyl group, or (v) an alkylaryl group, comprising substituted and unsubstituted alkylaryl groups, wherein the alkyl portion of the alkylaryl group can be linear or branched, saturated or unsaturated, or cyclic or acyclic, and wherein heteroatoms either may or may not be present in either the aryl or the alkyl portion of the alkylaryl group; and

n is from about 1 to about 20, from about 1 to about 15, from about 1 to about 10, or from about 1 to about 5. In one specific embodiment, R₂ is the formula —C₃₄H₅₆₊ₐ— and are branched alkylene groups which may include unsaturations and cyclic groups, wherein a is an integer of 0, 1, 2, 3, 4, 5, 6, 7, 8, 9, 10, 11, or 12, including, for example, isomers of the formula

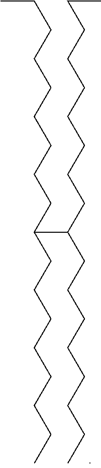 [SMILES: CCCCCCCCCC(CCCCCCCC)C(CCCCCCCC)CCCCCCCCC]

In one specific embodiment, R₁ is an ethylene (—CH₂CH₂—) group.

In one specific embodiment, R₃ is

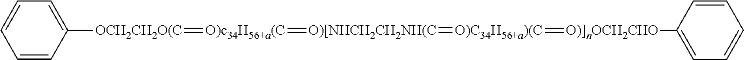

wherein —C₃₄H₅₆₊ₐ— represents a branched alkylene group which may include unsaturations and cyclic groups, wherein a is an integer of 0, 1, 2, 3, 4, 5, 6, 7, 8, 9, 10, 11, or 12, and n is 1 to about 20, from about 1 to about 15, from about 1 to about 10, or from about 1 to about 5, including, for example, isomers of the formula

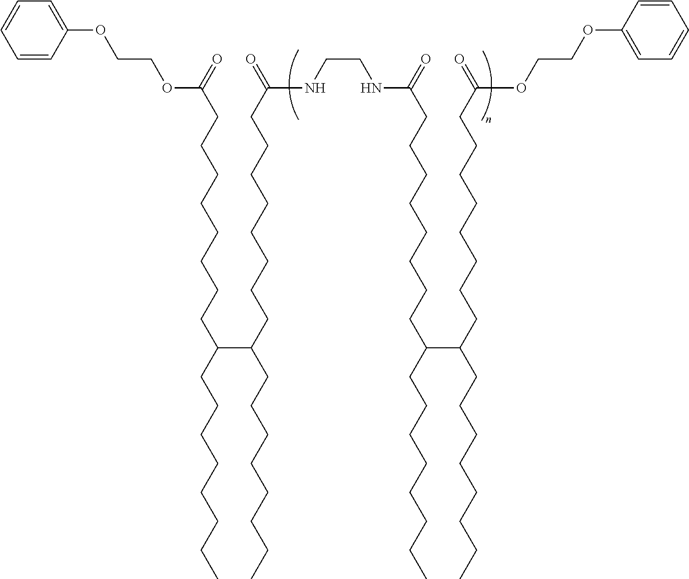

The gellant compounds as disclosed herein can be prepared by any desired or effective method.

For example, in embodiments, gellants can be prepared as described in U.S. Pat. No. 7,259,275, entitled “Method for Preparing Curable Amide Gellant Compounds,” with the named inventors Jennifer L. Belelie, Adela Goredema, Peter G. Odell, and Eniko Toma, and the disclosure of which is totally incorporated herein by reference, which describes a process for preparing a compound of the formula

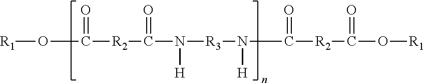

wherein R₁ is an alkyl group having at least one ethylenic unsaturation, an arylalkyl group having at least one ethylenic unsaturation, or an alkylaryl group having at least one ethylenic unsaturation, R₂ and R₃ each, independently of the others, are alkylene groups, arylene groups, arylalkylene groups, or alkylarylene groups, and n is an integer representing the number of repeat amide units and is at least 1, said process comprising: (a) reacting a diacid of the formula

HOOC—R₂—COOH

with a diamine of the formula

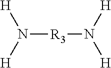

in the absence of a solvent while removing water from the reaction mixture to form an acid-terminated oligoamide intermediate; and (b) reacting the acid-terminated oligoamide intermediate with a monoalcohol of the formula

R₁—OH

in the presence of a coupling agent and a catalyst to form the product.

The gellant, gelling agent, or amide gellant is present in the ink in any desired or effective amount, in embodiments the amide gellant is present in an amount of from about 1 to about 30 percent by weight based upon the total weight of the ink, or from about 2 to about 20 percent by weight based upon the total weight of the ink, or from about 5 to about 12 percent by weight based upon the total weight of the ink.

The ink vehicles disclosed herein can comprise any suitable curable monomer or oligomer. Examples of suitable materials include radically curable monomer compounds, such as acrylate and methacrylate monomer compounds, which are suitable for use as phase change ink carriers.

The ultra-violet curable phase change gellant ink can comprise any suitable or desired acrylate monomer. In embodiments, the ink herein comprises at least one acrylate monomer.

Specific examples of acrylate and methacrylate monomers include (but are not limited to) isobornyl acrylate, isobornyl methacrylate, lauryl acrylate, lauryl methacrylate, isodecylacrylate, isodecylmethacrylate, caprolactone acrylate, 2-phenoxyethyl acrylate, isooctylacrylate, isooctylmethacrylate, butyl acrylate, alkoxylated lauryl acrylate, ethoxylated nonyl phenol acrylate, ethoxylated nonyl phenol methacrylate, ethoxylated hydroxyethyl methacrylate, methoxy polyethylene glycol monoacrylate, methoxy polyethylene glycol monomethacrylate, tetrahydrofurfuryl methacrylate, tetrahydrofurfuryl methacrylate and the like, as well as mixtures or combinations thereof. In addition, multifunctional acrylate and methacrylate monomers and oligomers can be included in the phase change ink carrier as reactive diluents and as materials that can increase the crosslink density of the cured image, thereby enhancing the toughness of the cured images. Examples of suitable multifunctional acrylate and methacrylate monomers and oligomers include (but are not limited to) pentaerythritol tetraacrylate, pentaerythritol tetramethacrylate, 1,2-ethylene glycol diacrylate, 1,2-ethylene glycol dimethacrylate, 1,6-hexanediol diacrylate, 1,6-hexanediol dimethacrylate, 1,12-dodecanol diacrylate, 1,12-dodecanol dimethacrylate, tris(2-hydroxy ethyl) isocyanurate triacrylate, propoxylated neopentyl glycol diacrylate, hexanediol diacrylate, tripropylene glycol diacrylate, dipropylene glycol diacrylate, ethoxylated bisphenol A diacrylate, ethoxylated bisphenol A dimethacrylate, alkoxylated hexanediol diacrylate, alkoxylated cyclohexane dimethanol diacrylate, polyethylene glycol diacrylate, polyethylene glycol dimethacrylate, tricyclodecane dimethanol diacrylate (available from Sartomer Co. Inc. as SR833 S®), tris (2-hydroxy ethyl) isocyanurate triacrylate, SR9012® a brand of trifunctional acrylate ester available from Sartomer Co. Inc, amine modified polyether acrylates (available as PO 83 F®, LR 8869®, and/or LR 8889® (all available from BASF Corporation)), trimethylolpropane triacrylate, glycerol propoxylate triacrylate, dipentaerythritol pentaacrylate, dipentaerythritol hexaacrylate, ethoxylated pentaerythritol tetraacrylate (available from Sartomer Co. Inc. as SR 494®), and the like, as well as mixtures and combinations thereof. When a reactive diluent is added to the ink carrier material, the reactive diluent is added in any desired or effective amount, in one embodiment at least about 1 percent by weight of the carrier, and in another embodiment at least about 35 percent by weight of the carrier, and in one embodiment no more than about 98 percent by weight of the carrier, and in another embodiment no more than about 75 percent by weight of the carrier, although the amount of diluent can be outside of these ranges.

The ink vehicles contain at least one compound that can exhibit gel-like behavior in that they undergo a relatively sharp increase in viscosity over a relatively narrow temperature range when dissolved in a liquid such as those compounds that behave as curable monomers when exposed to radiation such as ultraviolet light. Two examples of such a curable liquid monomer are propoxylated neopentyl glycol diacrylate and tricyclodecane dimethanol diacrylate (both available as SR9003® and SR833 S®, respectively, from Sartomer Co. Inc.). In one embodiment, some vehicles as disclosed herein undergo a change in viscosity of at least about 10³ centipoise, in another embodiment at least about 10⁵ centipoise, and in yet another embodiment at least about 10⁶ centipoise over a temperature range of in one embodiment at least about 30° C., in another embodiment at least about 10° C., and in yet another embodiment at least about 5° C., although the viscosity change and temperature range can be outside of these ranges, and vehicles that do not undergo changes within these ranges are also included herein.

The curable monomer or oligomer, for example acrylate monomer, is present in the ink in any desired or effective amount, in embodiments the acrylate monomer is present in an amount of from about 20 to about 90 percent by weight based upon the total weight of the ink, or from about 30 to about 80 percent by weight based upon the total weight of the ink, or from about 50 to about 70 percent by weight based upon the total weight of the ink.

In embodiments, the ultra-violet curable phase change gellant ink herein comprises at least one photoinitiator. Examples of photoinitiators used herein include (but are not limited to) benzophenone derivatives, benzyl ketones, monomeric hydroxyl ketones, polymeric hydroxyl ketones, α-amino ketones, acyl phosphine oxides, metallocenes, benzoin ethers, benzil ketals, α-hydroxyalkylphenones, α-aminoalkylphenones, acylphosphine photoinitiators sold under the trade designations of IRGACURE® and DAROCUR® from BASF, isopropyl thioxanthenones, arylsulphonium salts and aryl iodonium salts and the like, and mixtures and combinations thereof. Specific examples include 1-hydroxy-cyclohexylphenylketone, benzophenone, 2-benzyl-2-(dimethylamino)-1-(4-(4-morphorlinyl)phenyl)-1-butanone, 2-methyl-1-(4-methylthio)phenyl-2-(4-morphorlinyl)-1-propanone, diphenyl-(2,4,6-trimethylbenzoyl)phosphineoxide, oxide, phenyl bis(2,4,6-trimethylbenzoyl)phosphine oxide, benzyl-dimethylketal, isopropylthioxanthone, 2,4,6-trimethylbenzoyldiphenylphosphine oxide (available as BASF LUCIRIN TPO®), 2,4,6-trimethylbenzoylethoxyphenylphosphine oxide (available as BASF LUCIRIN TPO-L®), bis(2,4,6-trimethylbenzoyl)-phenyl-phosphine oxide (available as BASF IRGACURE® 819) and other acyl phosphines, 2-methyl-1-(4-methylthio)phenyl-2-(4-morphorlinyl)-1-propanone (available as BASF IRGACURE® 907) and 1-(4-(2-hydroxyethoxy)phenyl)-2-hydroxy-2-methylpropan-1-one (available as BASF IRGACURE® 2959), 2-benzyl 2-dimethylamino 1-(4-morpholinophenyl) butanone-1 (available as BASF IRGACURE® 369), 2-hydroxy-1-(4-(4-(2-hydroxy-2-methylpropionyl)-benzyl)-phenyl)-2-methylpropan-1-one (available as BASF IRGACURE® 127), 2-dimethylamino-2-(4-methylbenzyl)-1-(4-morpholin-4-ylphenyl)-butanone (available as BASF IRGACURE® 379), titanocenes, isopropylthioxanthone, 1-hydroxy-cyclohexylphenylketone, benzophenone, 2,4,6-trimethylbenzophenone, 4-methylbenzophenone, diphenyl-(2,4,6-trimethylbenzoyl)phosphine oxide, 2,4,6-trimethylbenzoylphenylphosphinic acid ethyl ester, oligo(2-hydroxy-2-methyl-1-(4-(1-methylvinyl)phenyl)propanone), 2-hydroxy-2-methyl-1-phenyl-1-propanone, benzyl-dimethylketal, and the like, as well as mixtures thereof.

Optionally, the phase change inks can also contain an amine synergist, which are co-initiators which can donate a hydrogen atom to a photoinitiator and thereby form a radical species that initiates polymerization, and can also consume dissolved oxygen, which inhibits free-radical polymerization, thereby increasing the speed of polymerization. Examples of suitable amine synergists include (but are not limited to) ethyl-4-dimethylaminobenzoate, 2-ethylhexyl-4-dimethylaminobenzoate, and the like, as well as mixtures thereof.

Initiators for inks disclosed herein can absorb radiation at any desired or effective wavelength, in one embodiment at least about 200 nanometers, and in one embodiment no more than about 560 nanometers, and in another embodiment no more than about 420 nanometers, although the wavelength can be outside of these ranges.

The initiator can be present in the ink in any desired or effective amount, in one embodiment at least about 0.5 percent by weight of the ink, and in another embodiment at least about 1 percent by weight of the ink, and in one embodiment no more than about 15 percent by weight of the ink, and in another embodiment no more than about 10 percent by weight of the ink, although the amount can be outside of these ranges.

In embodiments, the ultra-violet curable phase change gellant ink herein comprises a colorant. Any desired or effective colorant can be employed, including dyes, pigments, mixtures thereof, and the like, provided that the colorant can be dissolved or dispersed in the ink vehicle. Examples of suitable dyes include, but are not limited to, Usharect Blue 86 (Direct Blue 86), available from Ushanti Colour; Intralite Turquoise 8GL (Direct Blue 86), available from Classic Dyestuffs; Chemictive Brilliant Red 7BH (Reactive Red 4), available from Chemiequip; Levafix Black EB, available from Bayer; Reactron Red H8B (Reactive Red 31), available from Atlas Dye-Chem; D&C Red #28 (Acid Red 92), available from Warner-Jenkinson; Direct Brilliant Pink B, available from Global Colors; Acid Tartrazine, available from Metrochem Industries; Cartasol Yellow 6GF, available from Clariant; Carta Blue 2GL, available from Clariant; solvent dyes, including spirit soluble dyes such as Neozapon Red 492 (BASF); Orasol Red G (BASF); Direct Brilliant Pink B (Global Colors); Aizen Spilon Red C-BH (Hodogaya Chemical); Kayanol Red 3BL (Nippon Kayaku); Spirit Fast Yellow 3G; Aizen Spilon Yellow C-GNH (Hodogaya Chemical); Cartasol Brilliant Yellow 4GF (Clariant); Pergasol Yellow CGP (BASF); Orasol Black RLP (Ciba); Savinyl Black RLS (Clariant); Morfast Black Conc. A (Rohm and Haas); Orasol Blue GN (BASF); Savinyl Blue GLS (Sandoz); Luxol Fast Blue MBSN (Pylam); Sevron Blue 5GMF (Classic Dyestuffs); Basacid Blue 750(BASF); Neozapon Black X51 [C.I. Solvent Black, C.I. 12195] (BASF); Sudan Blue 670 [C.I. 61554] (BASF); Sudan Yellow 146[C.I. 12700] (BASF); Sudan Red 462 [C.I. 260501] (BASF); and the like, as well as mixtures thereof.

Pigments are also suitable colorants for the phase change inks. Examples of suitable pigments include PALIOGEN® Violet 5100 (BASF); PALIOGEN® Violet 5890 (BASF); HELIOGEN® Green L8730 (BASF); LITHOL® Scarlet D3700 (BASF); SUNFAST® Blue 15:4 (Sun Chemical); Hostaperm® Blue B2G-D (Clariant); Permanent Red P-F7RK; Hostaperm® Violet BL (Clariant); Permanent Rubine L5B 01 (Clairant); LITHOL® Scarlet 4440 (BASF); Bon Red® C (Dominion Color Company); ORACET® Pink RF (BASF); PALIOGEN® Red 3871 K (BASF); SUNFAST® Blue 15:3 and SUNFAST® 15:4 (Sun Chemical); PALIOGEN® Red 3340 (BASF); SUNFAST® Carbazole Violet 23 (Sun Chemical); LITHOL® Fast Scarlet L4300 (BASF); SUNBRITE® Yellow 17 (Sun Chemical); HELIOGEN® Blue L6900, L7020 (BASF); SUNBRITE® Yellow 74 (Sun Chemical); SPECTRA PAC® C Orange 16 (Sun Chemical); HELIOGEN® Blue K6902, K6910 (BASF); SUNFAST® Magenta 122 (Sun Chemical); HELIOGEN® Blue D6840, D7080 (BASF); Sudan Blue OS (BASF); NEOPEN® Blue FF4012 (BASF); PV Fast Blue B2GO1 (Clariant); IRGALITE® Blue BCA (BASF); PALIOGEN® Blue 6470 (BASF); Sudan Orange G (Aldrich), Sudan Orange 220 (BASF); PALIOGEN® Orange 3040 (BASF); PALIOGEN® Yellow 152, 1560 (BASF); LITHOL® Fast Yellow 0991 K (BASF); PALIOTOL® Yellow 1840 (BASF); NOVOPERM® Yellow FGL and NOVOPERM® Yellow P-HG (Clariant); Lumogen® Yellow D0790 (BASF); Suco-Yellow L1250 (BASF); Suco-Yellow D1355 (BASF); Suco Fast Yellow Dl 355, Dl 351 (BASF); HOSTAPERM® Pink E 02 (Clariant); Hansa Brilliant Yellow 5GX03 (Clariant); Permanent Yellow GRL 02 (Clariant); Permanent Rubine L6B 05 (Clariant); FANAL Pink D4830 (BASF); CINQUASIA® Magenta (DU PONT); PALIOGEN® Black L0084 (BASF); Pigment Black K801 (BASF); and carbon blacks such as REGAL 330™ (Cabot), Carbon Black 5250, Carbon Black 5750 (Columbia Chemical), Mogul® E (Cabot), and the like, as well as mixtures thereof.

In certain embodiments, the ultra-violet curable phase change gellant ink herein comprises at least one pigment. Any suitable or desired pigment can be selected including, but not limited to, the pigments described herein.

The colorant is present in the phase change ink in any desired or effective amount to obtain the desired color or hue, in embodiments from about 0.1 percent to about 15 percent by weight of the ink, or from about 0.2 percent to about 8 percent by weight of the ink, although the amount can be outside of these ranges.

In certain embodiments, the ultra-violet curable phase change gellant ink herein comprises a white colorant, which can be selected from dyes, pigments, mixtures thereof, and the like, provided that the colorant can be dissolved or dispersed in the ink vehicle.

In embodiments herein, the white colorant is a white pigment selected from titanium dioxide, zinc oxide, zinc sulfide, calcium carbonate, clay, lithopone (a mixture of barium sulphate and zinc sulfide), or mixtures or combinations thereof. In a specific embodiment, the white colorant is a titanium dioxide pigment. Commercial grades of TiO₂ are designed with additional artifacts to enhance optical properties such as tint strength and undertone and to promote dispersion stability. The pigment features include size, degree of coating with silica and or alumina, as well as optional organic materials. Illustrative examples of suitable titanium oxide pigments include pigments selected from Ti-Pure® R-108, Ti-Pure® R-104, Ti-Pure® R-103, Ti-Pure® R-102, Ti-Pure® R-700, Ti-Pure® R-706, Ti-Pure® R-760, Ti-Pure® R-900, Ti-Pure® R-960, available from DuPont Titanium Technologies, Wilmington, Del., 2020®,2063®,2090®,2310®,2450® available from Kronos Inc., Cranbury, N.J., and Tiona® 595, Tiona® 568, Tiona® RCL-6, Tiona® RCL-9, and Tiona® 696 available from Millennium Inorganic Chemicals, Hunt Valley, Md.

In embodiments, pigments selected herein can have a volume average particle size (diameter) of from about 150 to about 450 nanometers, or from about 200 to about 300 nanometers. In one embodiment, the white colorant is a titanium dioxide pigment having a particle size of from about 200 to about 300 nanometers.

The white colorant is present in the ink in any desired or effective amount, in embodiments the white colorant is present in an amount of from about 1 to about 60 percent by weight based upon the total weight of the ink, or from about 20 to about 40 percent by weight based upon the total weight of the ink. In one embodiment, the white colorant is a white pigment present in the ink an amount of about 1 to about 60 percent by weight based upon the total weight of the ink, or from about 20 to about 40 percent by weight based upon the total weight of the ink, or about 10 percent by weight based upon the total weight of the ink.

In embodiments, the ultra-violet curable phase change gellant ink comprises a white colorant comprising a white titanium dioxide pigment having a particle size of from about 200 to about 300 nanometers; a colorant dispersant; and an ink vehicle comprising at least one curable monomer, at least one photoinitiator, optionally at least one stabilizer, and optionally at least one wax.

In embodiments, the ultra-violet curable phase change gellant ink comprises an ink set comprising a plurality of differently colored curable phase change inks, wherein each colored ink of the ink set is comprised of an ink vehicle, a gelling agent, a pigment, and a dispersant, wherein the dispersant is identical in each colored ink of the ink set and the dispersant is present in a substantially same amount in each colored ink of the ink set. In embodiments, the ink used in the present process is selected from the inks described in U.S. Pat. No. 8,545,002, which is hereby incorporated by reference herein in its entirety.

In embodiments, the ink herein comprises a base ink set including at least two, and desirably three or four, phase change inks of different colors. A colored ink is an ink that exhibits a perceptible color to a viewer's naked eye, for example as a result of the ink including a colorant that exhibits the perceptible color. Desirably, a base ink set comprises four colored inks representing the CYMK colors. However, a base ink set can also comprise different colors, such as blue, green, red, violet, orange, white, and black. Each colored ink the base ink set is comprises of an ink vehicle, a pigment, and a dispersant. Each ink may utilize a different ink vehicle or may utilize the same ink vehicle. The dispersant of each colored ink of the ink set must be the same dispersant for all the colored inks in the ink set. Also, the amount of dispersant in each colored ink of the ink set desirably is presented in the colored inks in the same amount.

The ink set may also include a pigmentless (colorless) ink that may or may not contain the same dispersant, optionally in the same amount or a different amount (if present), as the colored inks of the base ink set. The pigmentless phase change ink can be used in forming a custom color ink that is a lighter shade in color, by mixing the pigmentless ink with one or more colored inks of the ink set, or may be used in cleaning of an ink jet apparatus.

Using the same pigment dispersant in the same amount across all colored inks of an ink set can eliminate interactions between the dispersants and/or unintended pigment-dispersant interactions when the inks are mixed in forming a custom color.

The radiation curable phase change inks can also, if desired, contain additives to take advantage of the known functionality associated with such additives. Such additives may include, for example, defoamers, slip and leveling agents, pigment dispersants, and the like, as well as mixtures and combinations thereof. The inks can also include additional monomeric or polymeric materials as desired.

Any suitable or desired additives can be selected. In embodiments, dispersants can be random and block copolymers, such as an amino acrylate block copolymer, for example including an amino or amino acrylate block A and an acrylate block B, the acrylate portions permitting the dispersant to be stably and well dispersed in the ink vehicle while the amino portions adsorb well to pigment surfaces. Commercially available examples of block copolymer dispersants include DISPERBYK-2001® (BYK Chemie GmbH) and EFKA® 4340 polymeric pigment dispersant available from BASF Corporation.

In embodiments, a base ink set comprises colored inks that each include the same dispersant or same combination of dispersants, such that there is no difference among the dispersant component in each of the colored inks of the ink set. Each colored ink of the ink set desirably includes the same total amount of the dispersant compared to the other colored inks of the ink set. The dispersant may be added to the ink in any suitable or desired amount, in embodiments at from about 20 to about 200 percent by weight relative to the pigment, such as from about 20 to about 150 percent by weight relative to the pigment, or form about 20 to about 100 percent by weight relative to the pigment.

The pigment and dispersant may be added to the ink as a dispersion of the pigment and dispersant. The pigment dispersion may have a solids percentage of from about 5 to about 50 percent, such as from about 50 to about 40 percent, or from about 10 to about 40 percent.

The radiation curable phase change inks herein can also optionally contain an antioxidant. The optional antioxidants can protect the images from oxidation and can also protect the ink components from oxidation during the heating portion of the ink preparation process. Specific examples of suitable antioxidant stabilizers include (but are not limited to) NAUGARD® 524, NAUGARD® 635, NAUGARD® A, NAUGARD® 1-403, and NAUGARD® 959, commercially available from Crompton Corporation, Middlebury, Conn.; IRGANOX® 1010 and IRGASTAB® UV 10, previously commercially available from Ciba Specialty Chemicals; GENORAD® 16 and GENORAD® 40 commercially available from Rahn AG, Zurich, Switzerland, and the like, as well as mixtures thereof. When present, the optional antioxidant is present in the ink in any desired or effective amount, in one embodiment at least about 0.01 percent by weight of the ink carrier, in another embodiment at least about 0.1 percent by weight of the ink carrier, and in yet another embodiment at least about 1 percent by weight of the ink carrier, and in one embodiment no more than about 20 percent by weight of the ink carrier, in another embodiment no more than about 5 percent by weight of the ink carrier, and in yet another embodiment no more than about 3 percent by weight of the ink carrier, although the amount can be outside of these ranges.

Curing of the ink can be effected by exposure of the ink image to actinic radiation at any desired or effective wavelength, in embodiments from about 200 nanometers to about 480 nanometers, although the wavelength can be outside of this range. Exposure to actinic radiation can be for any desired or effective period of time, in embodiments for about 0.2 second to about 30 seconds, or from about 1 second to 15 seconds, although the exposure period can be outside of these ranges. By curing is meant that the curable compounds in the ink undergo an increase in molecular weight upon exposure to actinic radiation, such as (but not limited to) crosslinking, chain lengthening, or the like.

The ink compositions generally have melt viscosities at the jetting temperature (in embodiments no lower than about 50° C., no lower than about 60° C., no lower than about 70° C., or no higher than about 120° C., or no higher than about 110° C., although the jetting temperature can be outside of these ranges) in embodiments no more than about 30 centipoise, no more than about 20 centipoise, or no more than about 15 centipoise, or no less than about 2 centipoise, no less than about 5 centipoise, or no less than about 7 centipoise, although the melt viscosity can be outside of these ranges.

In embodiments, the ultra-violet curable phase change gellant ink comprises an ink having a visocity of from about 10 to about 16 centipoise at a temperature of from about 70° C. to about 95° C. and a freezing temperature of from about 30° C. to about 60° C.

The radiation curable phase change inks can also, if desired, contain additives to take advantage of the known functionality associated with such additives. Such additives may include, for example, defoamers, slip and leveling agents, pigment dispersants, and the like, as well as mixtures and combinations thereof. The inks can also include additional monomeric or polymeric materials as desired.

Curing of the ink can be effected by exposure of the ink image to actinic radiation at any desired or effective wavelength, in embodiments from about 200 nanometers to about 480 nanometers, although the wavelength can be outside of this range. Exposure to actinic radiation can be for any desired or effective period of time, in embodiments for about 0.2 second to about 30 seconds, or from about 1 second to 15 seconds, although the exposure period can be outside of these ranges. By curing is meant that the curable compounds in the ink undergo an increase in molecular weight upon exposure to actinic radiation, such as (but not limited to) crosslinking, chain lengthening, or the like. In embodiments, the inks are ultra-violet curable phase change inks.

The ink compositions can be prepared by any desired or suitable method. For example, the ink ingredients can be mixed together, followed by heating, to a temperature in one embodiment of at least about 80° C., and in one embodiment of no more than about 120° C., although the temperature can be outside of these ranges, and stirring until a homogeneous ink composition is obtained, followed by cooling the ink to ambient temperature (typically from about 20° C. to about 25° C.). The inks are solid at ambient temperature.

Depositing the one or more layers of ultra-violet curable phase change ink can comprises ink jetting the one or more layers. Each individual layer can be any suitable or desired thickness or print height. In embodiments, each layer of the one or more layers of ultra-violet curable phase change ink is from about 10 micrometers to about 5 millimeters in thickness.

In embodiments, when multiple layers are successively printed, the layers can be cured upon completion of deposition of a last of the multiple layers. In another embodiment, each layer can be cured prior to the deposition of a subsequent layer. Thus, in embodiments, curing comprises curing each layer of the one or e more layers of ultra-violet curable phase change ink prior to depositing the next layer of ultra-violet curable phase change ink, or curing comprises curing after depositing the last layer of the one or more layers of ultra-violet curable phase change gellant ink.

The inks herein, as well as the methods herein, may be employed with any desired printing system and marking material suitable for applying a marking material in an imagewise pattern directly to an image receiving recording medium, such as ink jet printing, thermal ink jet printing, piezoelectric ink jet printing, acoustic ink jet printing, and the like.

In embodiments, the process herein comprises depositing the support, scaffold, or mold and depositing the one or more layers of the ultra-violet curable phase change gellant ink comprises depositing by ink jetting.

The inks can be employed in apparatus for direct printing ink jet processes and in indirect printing ink jet applications. Another embodiment disclosed herein is directed to a process which comprises incorporating an ink as disclosed herein into an ink jet printing apparatus, melting the ink, and causing droplets of the melted ink to be ejected in an imagewise pattern onto a recording substrate. A direct printing process is also disclosed in, for example, U.S. Pat. No. 5,195,430, the disclosure of which is totally incorporated herein by reference. In one specific embodiment, the printing apparatus employs a piezoelectric printing process wherein droplets of the ink are caused to be ejected in imagewise pattern by oscillations of piezoelectric vibrating elements. Inks as disclosed herein can also be employed in other hot melt printing processes, such as hot melt acoustic ink jet printing, hot melt thermal ink jet printing, hot melt continuous stream or deflection ink jet printing, and the like. Phase change inks as disclosed herein can also be used in printing processes other than hot melt ink jet printing processes.

In a specific embodiment, the ultra-violet curable phase change gellant inks herein are employed in an ink jet printing device comprising an ink jet print head and a print region surface toward which ink is jetted from the ink jet print head, wherein a height distance between the ink jet print head and the print region surface is adjustable; wherein the ink jet print head jets an ultra-violet curable phase change ink composition as described herein.

In certain embodiments, a process herein comprises depositing a non-curable wax to form a support or a mold; providing an ultra-violet curable phase change gellant ink comprising an ink set comprising a plurality of differently colored curable phase change inks, wherein each colored ink of the ink set is comprised of an ink vehicle, a gelling agent, a pigment, and a dispersant, wherein the dispersant is identical in each colored ink of the ink set and the dispersant is present in a substantially same amount in each colored ink of the ink set; combining at least two inks from the ink set prior to depositing; melting the at least two inks; mixing the at least two inks to form a custom color ultra-violet curable phase change gellant ink; depositing one or more layers of the custom color ultra-violet curable phase change gellant ink onto the non-curable wax support or mold; optionally, cooling the deposited one or more layers of the custom color ultra-violet curable phase change gellant ink; curing the one or more layers of the ultra-violet curable phase change gellant ink layer or layers; and removing the non-curable wax support or mold. In embodiments, the colored inks of the ink set comprise a yellow ink, a cyan ink, a magenta ink, and optionally a black ink; or wherein the colored inks of the ink set comprise a green ink, an orange ink, a violet ink, optionally a white ink, and optionally a black ink.

In other embodiments, a process herein comprises depositing a non-curable wax to form a support or a mold; depositing one or more layers of an ultra-violet curable phase change gellant ink onto the non-curable wax support or mold; wherein the surface of the deposited support or mold is untreated and the one or more layers of ultra-violet curable phase change gellant ink are deposited onto the untreated non-curable wax support or mold; curing the ultra-violet curable phase change gellant ink layer or layers; and removing the non-curable wax support or mold. In embodiments, the ultra-violet curable phase change gellant ink comprises an ink set comprising a plurality of differently colored curable phase change inks, wherein each colored ink of the ink set is comprised of an ink vehicle, a gelling agent, a pigment, and a dispersant, wherein the dispersant is identical in each colored ink of the ink set and the dispersant is present in a substantially same amount in each colored ink of the ink set; and the process further comprises combining at least two inks from the ink set prior to depositing; melting the at least two inks; mixing the at least two inks to form a custom color ultra-violet curable phase change gellant ink; wherein depositing one or more layers of the ultra-violet curable phase change gellant ink onto the non-curable wax support or mold comprises depositing one or more layers of the custom color ultra-violet curable phase change gellant ink onto the non-curable wax support or mold.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

### Examples 1-4

Ultra-violet curable gellant inks were prepared having the components as shown in Table 1 .

TABLE 1

Example, wt %

| Component | 1 | 2 | 3 | 4 |
|---|---|---|---|---|
| Amide gellant | 7.5 | 7.5 | 7.5 | 7.5 |
| SR833S | 69.8 | 66.47 | 69.8 | 68.75 |
| SR399LV | 5.0 | 5.0 | 5.0 | 5.0 |
| Irgacure ® 379 | 3.0 | 3.0 | 3.0 | 3.0 |
| Irgacure ® 819 | 0.5 | 0.5 | 0.5 | 0.5 |
| Esacure ® KP 150 | 4.0 | 4.0 | 4.0 | 4.0 |
| Irgastab ® UV 10 | 0.2 | 0.2 | 0.2 | 0.2 |
| 20% Sunfast | 10.0 | | | |
| Blue 15:4 | | | | |
| pigment (Sun | | | | |
| Chemical), 20% | | | | |
| EFKA 4340, | | | | |
| 40% SR9003 | | | | |
| 15% Permanent | | 13.33 | | |
| Rubine L5B 01 | | | | |
| magenta pigment | | | | |
| (Clariant), 15% | | | | |
| EFKA 4340, | | | | |
| 70% SR9003 | | | | |
| 20% Novoperm | | | 10.0 | |
| Yellow P-HG | | | | |
| pigment | | | | |
| (Clariant), 20% | | | | |
| EFKA 4340, | | | | |
| 40% SR9003 | | | | |
| 18.1% Mogul E | | | | 11.05 |
| black pigment | | | | |
| (Cabot), 18.1% | | | | |
| EFKA 4340, | | | | |
| 63.8% SR9003 | | | | |
| TOTAL | 100 | 100 | 100 | 100 |

The amide gellant was prepared as described in U.S. Pat. No. 8,142,557, which is hereby incorporated by reference herein in its entirety.

SR833 S is a monomer (tricyclodecane dimethanol diacrylate) available from Sartomer Chemical Corp.

SR399LV is dipentaerythritol pentaacrylate, available from Sartomer Chemical Corp.

Irgacure® 379 is a photoinitiator, 2-dimethylamino-2-(4-methylbenzyl)-1-(1-(4-morpholin-4-ylphenyl)-butanone, available from BASF Corporation.

Irgacure® 819 is a photoinitiator, bis(2,4,6-trimethylbenzoyl)-phenyl-phosphine oxide, available from BASF Corporation.

Esacure® KP 150 is an oligomeric alpha hydroxyketone photoinitiator, Oligo [2-hydroxy-2-methyl-1-[4-(1-methylvinyl)phenyl]propanone], available from Lamberti.

Irgastab® UV 10 is an in-can nitroxide-based stabilizer previously commercially available from Ciba Specialty Chemicals.

The compositions of the pigment dispersions are described in Table 1. Each contains the desired pigment [Sunfast Blue 15:4 pigment (Sun Chemical), Permanent Rubine L5B 01 magenta pigment (Clariant), Novoperm Yellow P-HG pigment (Clariant) or Mogul E black pigment (Cabot)] and an equal amount of EFKA® 4340 polymeric pigment dispersant available from BASF Corporation with the balance comprised of SR9003®, propoxylated neopentyl glycol diacrylate, a liquid curable difunctional monomer, commercially available from Sartomer Co. Inc.

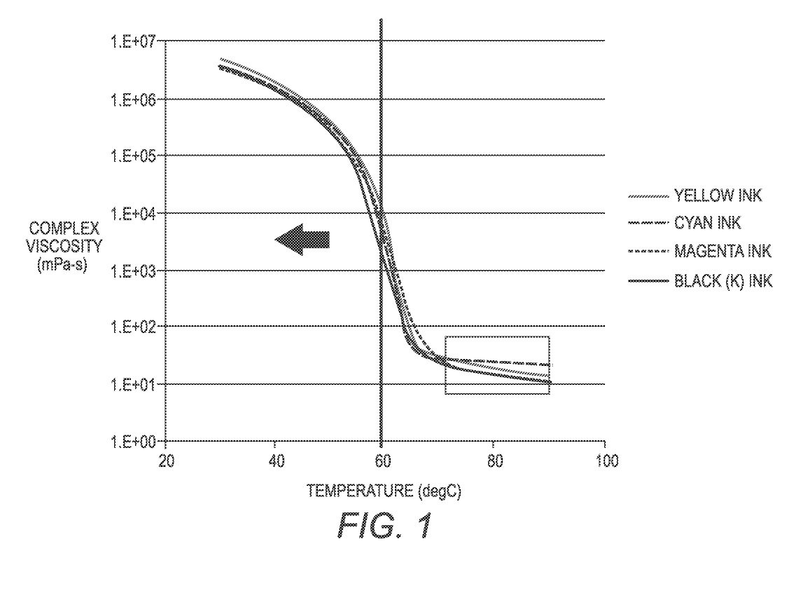

FIG. 1 shows a viscosity profile for yellow, cyan, magenta, and black ink versions of ultra-violet curable phase change gellant inks of Examples 1-4.

### Examples 5-7

A number of support materials can be used in combination with the curable gel composition of Examples 1-4. Suitable are, for example, the ink formulations of U.S. Pat. No. 6,153,667 (Pelikan Produktions, AG, Switzerland), which is hereby incorporated by reference herein in its entirety, which melt below 100° C. and are jettable at a temperature of about 90 to 100° C.

Even more suitable are the inks of U.S. Pat. No. 7,665,835 (Xerox), which is hereby incorporated by reference herein in its entirety, in embodiments, Examples 1 to 6, Examples 4, 5 and 6 containing a urea gellant and a low molecular weight alkylene wax. If a higher jetting temperature is required, one can select compositions such as those disclosed in Example A and B of U.S. Pat. No. 7,572,325, which is hereby incorporated by reference herein in its entirety.

Representative examples of colorless suitable materials are also formulated using the materials disclosed in U.S. Pat. No. 7,665,835, which is hereby incorporated by reference herein in its entirety.

### Example 5

A support material was prepared in a 50 ml beaker by adding (1) 18.0 grams (90 wt %) of behenyl behenate (Kester® Wax 72, obtained from Kester Keunen, Watertown, Conn.) and (2) 2.0 grams (10 wt %) of didodecylurea prepared as in Example 1 of 7,665,835. The materials were melted together at a temperature of about 135° C. in a reaction block (from H+P Labortechnik GmbH, Munchen) controlled with a Telemodel 40CT, stirred for 2 hours at 500 rpm, and then cooled to room temperature. The support material had a viscosity of 5.64 centipoise as measured by an RFS strain-controlled rheometer from TA Instruments equipped with parallel sample geometry at 110° C.

### Example 6

A support material was prepared as described in Example 5 above except that Polywax® 500, obtained from Baker Petrolite, Tulsa, Okla., a polyethylene homopolymer with an average chain length of C-36, was also added. Relative amounts of the ingredients in this support material, expressed in wt % of the support material, are 70% Kester® Wax 72, 20% Polywax® 500 and 10% didodecylurea. The support material thus prepare exhibited a viscosity of 5.56 centipoise as measured by an RFS strain-controlled rheometer from TA Instruments equipped with parallel sample geometry at 110° C.

### Example 7

A support material was prepared in a 150 ml beaker by adding (1) 86.10 grams (71.75 wt %) of Kester® Wax 72, (2) 24.00 grams (20 wt %) of Polywax® 500, (3) 9.00 grams (7.5 wt %) of the didodecylurea from Example 1 of U.S. Pat. No. 7,665,835, and (4) 0.30 grams (0.25 wt %) of NAUGUARD® 445 antioxidant (obtained from Uniroyal Chemical Co., Middlebury, Conn.). The materials were melted together at a temperature of about 135° C. in a reaction block (from H +P Labortechnik GmbH, Munchen) controlled with a Telemodel 40CT, and stirred for about 3 hours at about 500 rpm. The support material was filtered through a heated MOTT® apparatus (obtained from Mott Mettallurgical) using a NAE 0.2 micron filter under a pressure of about 15 pounds per square inch. The filtered support material was poured in an aluminum mold and allowed to solidify. The support material thus prepared exhibited a viscosity of about 5.8 centipoise as measured by an RFS strain-controlled rheometer from TA Instruments equipped with parallel sample geometry at 110° C.

### Example 8

Selective Deposition Modelling Print Process.

A combination of the support material and build UV curable gel material are printed using an apparatus similar to the Selective Deposition Modelling system described in U.S. Pat. No. 8,642,692, which is hereby incorporated by reference herein in its entirety. The build and support materials are dispensed via inkjet print heads. After the support is inkjet printed, the UV curable gel ink is applied to the support. When the fabrication is complete, the entire object is exposed to UV radiation to cure the build material to form a robust object. After this point, the support material can be removed by either washing, melting or blasting, depending on its composition.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A process comprising:
depositing a non-curable wax to form a support or a mold;
depositing one or more layers of an ultra-violet curable phase change gellant ink onto the non-curable wax support or mold;
curing the ultra-violet curable phase change gellant ink layer or layers; and
removing the non-curable wax support or mold.

2. The process of claim 1, wherein depositing the non-curable wax comprises ink jetting the non-curable wax to form the support or mold.

3. The process of claim 1, wherein depositing the one or more layers of the ultra-violet curable phase change gellant ink comprises ink jetting the one or more layers of ultra-violet curable phase change gellant ink.

4. The process of claim 1, wherein the non-curable wax comprises a member of the group consisting of ester waxes, alcohol waxes, acid waxes, hydrocarbon waxes, and mixtures and combinations thereof.

5. The process of claim 1, wherein the ultra-violet curable phase change gellant ink comprises an amide gellant, at least one acrylate monomer, at least one photoinitiator, and at least one pigment.

6. The process of claim 1, wherein the ultra-violet curable phase change gellant ink comprises an ink having a viscosity of from about 10 to about 16 centipoise at a temperature of from about 70° C. to about 95° C. and a freezing temperature of from about 30° C. to about 60° C.

7. The process of claim 1, wherein the ultra-violet curable phase change gellant ink comprises at least one gellant of the formula 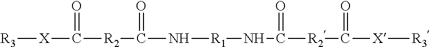
wherein R₁ is (i) an alkylene group, (ii) an arylene group, (iii) an arylalkylene group, or (iv) an alkylarylene group, R₂ and R₂ each, independently of the other, are (i) alkylene groups, (ii) arylene groups, (iii) arylalkylene groups, or (iv) alkylarylene groups, R₃ and R₃ each, independently of the other, are groups which are (i) alkyl groups, (ii) aryl groups, (iii) arylalkyl groups, or (iv) alkylaryl groups, and X and X′ each, independently of the other, is an oxygen atom or a group of the formula —NR₄—, wherein R₄ is (i) a hydrogen atom, (ii) an alkyl group, (iii) an aryl group, (iv) an arylalkyl group or (v) an alkylaryl group.

8. The process of claim 1, wherein the ultra-violet curable phase change gellant ink comprises a white colorant comprising a white titanium dioxide pigment having a particle size of from about 200 to about 300 nanometers; a colorant dispersant; and an ink vehicle comprising at least one curable monomer, at least one photoinitiator, optionally at least one stabilizer, and optionally at least one wax.

9. The process of claim 1, wherein the ultra-violet curable phase change gellant ink comprises an ink set comprising a plurality of differently colored curable phase change inks, wherein each colored ink of the ink set is comprised of an ink vehicle, a gelling agent, a pigment, and a dispersant, wherein the dispersant is identical in each colored ink of the ink set and the dispersant is present in a substantially same amount in each colored ink of the ink set.

10. The process of claim 1, wherein each layer of the one or more layers of ultra-violet curable phase change gellant ink is from about 10 micrometers to about 5 millimeters in thickness.

11. The process of claim 1, wherein curing comprises curing after depositing the last layer of the one or more layers of ultra-violet curable phase change gellant ink.

12. The process of claim 1, wherein the surface of the deposited support or mold is untreated and the one or more layers of an ultra-violet curable phase change gellant ink are deposited onto the untreated non-curable wax support or mold.

13. A process comprising:
depositing a non-curable wax to form a support or a mold;
providing an ultra-violet curable phase change gellant ink comprising an ink set comprising a plurality of differently colored curable phase change inks, wherein each colored ink of the ink set is comprised of an ink vehicle, a gelling agent, a pigment, and a dispersant, wherein the dispersant is identical in each colored ink of the ink set and the dispersant is present in a substantially same amount in each colored ink of the ink set;
combining at least two inks from the ink set prior to depositing;
melting the at least two inks;
mixing the at least two inks to form a custom color ultra-violet curable phase change gellant ink;
depositing one or more layers of the custom color ultra-violet curable phase change gellant ink onto the non-curable wax support or mold;
optionally, cooling the deposited one or more layers of the custom color ultra-violet curable phase change gellant ink;
curing the one or more layers of the ultra-violet curable phase change gellant ink layer or layers; and
removing the non-curable wax support or mold.

14. The process of claim 13, wherein the colored inks of the ink set comprise a yellow ink, a cyan ink, a magenta ink, and optionally a black ink; or wherein the colored inks of the ink set comprise a green ink, an orange ink, a violet ink, optionally a white ink, and optionally a black ink.

15. The process of claim 13, wherein the non-curable wax comprises a member of the group consisting of ester waxes, alcohol waxes, acid waxes, hydrocarbon waxes, and mixtures and combinations thereof.

16. The process of claim 13, wherein the ultra-violet curable phase change gellant ink comprises an amide gellant, at least one acrylate monomer, at least one photoinitiator, and at least one pigment.

17. The process of claim 13, wherein the ultra-violet curable phase change gellant ink comprises at least one gellant of the formula 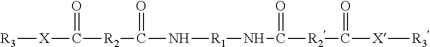
wherein R₁ is (i) an alkylene group, (ii) an arylene group, (iii) an arylalkylene group, or (iv) an alkylarylene group, R₂ and R₂ each, independently of the other, are (i) alkylene groups, (ii) arylene groups, (iii) arylalkylene groups, or (iv) alkylarylene groups, R₃ and R₃ each, independently of the other, are groups which are (i) alkyl groups, (ii) aryl groups, (iii) arylalkyl groups, or (iv) alkylaryl groups, and X and X′ each, independently of the other, is an oxygen atom or a group of the formula —NR₄—, wherein R₄ is (i) a hydrogen atom, (ii) an alkyl group, (iii) an aryl group, (iv) an arylalkyl group or (v) an alkylaryl group.

18. The process of claim 13, wherein the surface of the deposited support or mold is untreated and the one or more layers of the custom color ultra-violet curable phase change gellant ink are deposited onto the untreated non-curable wax support or mold.

19. A process comprising:
depositing a non-curable wax to form a support or a mold;
depositing one or more layers of an ultra-violet curable phase change gellant ink onto the non-curable wax support or mold;
wherein the surface of the deposited support or mold is untreated and the one or more layers of ultra-violet curable phase change gellant ink are deposited onto the untreated non-curable wax support or mold;
curing the ultra-violet curable phase change gellant ink layer or layers; and
removing the non-curable wax support or mold.

20. The process of claim 19, wherein the ultra-violet curable phase change gellant ink comprises an ink set comprising a plurality of differently colored curable phase change inks, wherein each colored ink of the ink set is comprised of an ink vehicle, a gelling agent, a pigment, and a dispersant, wherein the dispersant is identical in each colored ink of the ink set and the dispersant is present in a substantially same amount in each colored ink of the ink set; further comprising:
combining at least two inks from the ink set prior to depositing;
melting the at least two inks;
mixing the at least two inks to form a custom color ultra-violet curable phase change gellant ink;
wherein depositing one or more layers of the ultra-violet curable phase change gellant ink onto the non-curable wax support or mold comprises depositing one or more layers of the custom color ultra-violet curable phase change gellant ink onto the non-curable wax support or mold.
